(19) United States
(12) Patent Application Publication
(10) Pub. No.: US 2002/0116709 A1
(43) Pub. Date: Aug. 22, 2002

(54) Television receiver

(76) Inventors: Tatsuhiko Sakamoto, Tokyo (JP); Teruo Tobe, Tokyo (JP); Hitoshi Ohura, Tokyo (JP); Haruo Mukai, Tokyo (JP); Tomoyuki Ishii, Kawasaki (JP)

Correspondence Address: Rosenman & Colin LLP, 575 Madison Avenue, New York, NY, 10022-2585, US

(21) Appl. No.: 10/115,814

(22) Filed: Apr. 2, 2002

Related U.S. Application Data
(63) Continuation of application No. PCT/JP99/05858, filed on Oct. 22, 1999.

(51) Int. Cl. H04N 5/445

(52) U.S. Cl. 725/41; 725/39

(57) ABSTRACT

The present invention aims at providing a television receiver including a display screen capable of, in a television broadcast consisting of a multiplicity of channels, displaying information on programs being broadcast at other channels simultaneously with displaying an on-watching program. A television receiver of the present invention, comprises a screen including a channel name display area, a program schedule display area for displaying information containing a schedule of programs broadcast at channels displayed in the channel name display area, and a television broadcast display area for displaying the television broadcast received, and a display channel selection module for selecting the channel displayed in the channel name display area.

This is a continuation of Application PCT/JP 99/05858, filed on Oct. 22, 1999, now abandoned.

### BACKGROUND OF THE INVENTION

The present invention relates generally to a television receiver and more particularly to a television receiver incorporating a screen display function suitable for grasping contents of programs when receiving multi-channel TV broadcasts such as CATV, satellite broadcasts or ground wave digital broadcasts.

This type of known television receiver includes, as in the case of a picture display device disclosed in Japanese Patent Application Laying-Open Publication No. 8-125996, a main screen area for displaying a received picture, a title menu area for displaying a plurality of program titles for selecting a program, and a telop display area for displaying the contents of the programs in a text format.

In this picture display device, the picture of the program received is displayed in the main screen area, and the program displayed on the main screen can be changed by operating the title menu area with an operating means.

Further, the telop display area displaying a title of the program scheduled to be broadcast next, a special newscast, results of sport games etc, and the program on the main screen are displayed in a side-by-side relationship.

Further, a TV receiver disclosed in Japanese Patent Application Laying-Open Publication No.9-154076, is provided with a TV program display window for displaying a TV program to be watched and an operation button display window. This operation button display window displays the channel numbers of respective broadcasting stations, a name of the program that is now being broadcast and an outline of the content thereof. Further, when pressing a program reservation button a list of programs of each broadcasting station is displayed on the entire display screen, and a program display can be reserved based on this program list.

The prior art, however, has such a problem that the areas of the main screen for displaying the program received and of the TV program display window diminish due to the space for the title menu area for selecting the broadcast program and the operation button display window. Further, there must be prepared the title menu areas and the operation button display windows of which the numbers each correspond to the number of the receivable broadcasting stations (channels), and it is difficult to apply this scheme to multi-channel TV broadcasts such as the CATV, the satellite broadcasts or ground waves digital broadcasts. Further, the program reservation method disclosed as the prior art has an in convenience in which the display screen must be temporarily switched over to the program list display screen in order to confirm the program reserved.

### SUMMARY OF THE INVENTION

It is an object of the present invention, which was devised in view of the problems inherent in the prior arts described above, to provide a television receiver including a screen on which information on on-broadcasting programs at non-watching channels or information on programs that will be broadcast from now on can be confirmed simultaneously with displaying an on-watching program in television broadcasts consisting of a multiplicity of channels.

It is another object of the present invention to provide a display screen on which a program schedule and a program reservation can be easily confirmed in the TV broadcasts consisting of the multiplicity of channels such as digital broadcasts etc.

It is a further object of the present invention to provide a television receiver capable of displaying a screen for confirming the program schedule and the program reservation simultaneously with displaying the on-watching program, and enabling a user to watch the program on the entire screen by a simple operation.

To accomplish the above objects, the present invention adopts the following means. Namely, according to one aspect of the present invention, a television receiver comprises a screen including a channel name display area, a program schedule display area for displaying information containing a schedule of programs broadcast at channels displayed in the channel name display area, and a television broadcast display area for displaying the television broadcast received, and a display channel selection module for selecting the channel displayed in the channel name display area.

The program schedule display area and the television broadcast display area are provided on the same screen, and therefore a viewer is able to confirm the program schedule and to watch the television broadcast in parallel.

The screen may further include an information display area for displaying information about an on-broadcast program or information on the program scheduled to be broadcast, and information on programs to be broadcast at the channels of the television broadcasts received or programs to be broadcast at other channels, maybe displayed in the information display area. The information on the programs to be broadcast at the channels other than the on-watching channel is displayed in this information display area, and hence the viewer is able to watch the TV broadcast and to confirm contents of the programs of other channels in parallel.

The television receiver may further comprise enlargement indicating unit for indicating an enlargement of the television broadcast display area, wherein the television broadcast display area may be, upon the indication by the enlargement indicating unit, enlarged and displayed over the entire screen. As a result, the viewer can watch the picture of the television on the entire screen of the TV receiver.

The television receiver may further comprise indicating unit for indicating the program schedule display area, wherein the channel of the television broadcast received may be switched over by indicating a position related to the program schedule display area.

The television receiver may further comprise indicating unit for indicating the program schedule display area, wherein the information related to the program shown in the program schedule may be displayed by indicating a position related to the program schedule display area.

The program schedule display area displays the program schedule, starting from a program that is now being broadcast or a program of which the broadcast starts earliest at and after the present time.

The television receiver may further comprise a scroll area for scrolling the program schedule.

According to another aspect of the present invention, a television receiver comprises a screen including a program reservation information display area for displaying program reservation information extending to one or more broadcast channels and including combinations of information of one or more reserved programs to be watched and information containing a broadcast time and a broadcast channel of each of the reserved programs, and a television broadcast display area for displaying an on-receiving television broadcast. The viewer is thereby able to confirm the program reservation information and to watch the television broadcast on the same screen.

The program reservation information display area may display the program reservation information, starting from a program that is now being broadcast or a program of which the broadcast starts earliest at and after the present time.

The broadcast channel received when it is a broadcasting time of the program reserved by the program reservation information, may be switched over to a broadcast channel of the reserved program.

The information on the reserved program may be displayed at the broadcasting time of the program reserved by the program reservation information or before a predetermined time since this broadcasting time. Owing to this display mode, the user can recognize the start of broadcasting the reserved program and can prevent missing the program.

The television receiver may further comprise a scroll area for scrolling the program reservation information.

The television receiver may further comprise a volume adjusting module for adjusting a volume of the television broadcast received, a mute switching module for mute-switching, or a receiving channel switching module for switching over the broadcast channel received.

According to a further aspect of the present invention, there is provided a readable-by-computer recording medium recorded with a program, to make a computer control television receiver, comprising a step of displaying a screen including a channel name display area, a program schedule display area for displaying information containing a schedule of programs broadcast at channels displayed in the channel name display area, and a television broadcast display area for displaying the television broadcast received, wherein confirming the program schedule and watching the television broadcast on said same screen are enabled. Herein, the readable-by-computer recording medium is a recording medium capable of storing information such as data, programs, etc. electrically, magnetically, optically and mechanically or by chemical action, which can be read by the computer. The present invention can be also actualized by executing this program in the computer.

As described above, according to the present invention, the program schedule display area and the information display area are provided on the same screen as the television broadcast display area is provided. Therefore, it is possible to display the program schedule, the information on the on-broadcasting programs at other channels or the information on the programs which will be broadcast from now on in parallel with displaying the on-watching program.

Further, according to the present invention, the display channel selection area for selecting the channel of which program schedule is displayed is provided and the program schedule of every channel is displayed. Hence, there is no necessity of preparing the area for simultaneously displaying the program schedules of all the broadcast channels. Therefore, the present invention can be applied to the TV broadcasts consisting of the multiplicity of channels such as the digital broadcasts and so on.

Moreover, according to the present invention, the program to be watched can be displayed on the entire screen in response to a request of the viewer.

### BRIEF DESCRIPTION OF THE DRAWINGS

FIG. 1 is a view showing an architecture of a TV receiver in an embodiment of the present invention;

FIG. 2 is a block diagram showing an architecture of a microcomputer unit 1 shown in FIG. 1;

FIG. 3 is diagram showing a layout of a display screen of the TV receiver in the embodiment of the present invention;

FIG. 4 is a diagram showing a pull-down menu for selecting a channel in a channel name display box;

FIG. 5 is a view showing a display example of the TV receiver in the embodiment of the present invention;

FIG. 6 is a view showing a display example of the TV receiver in the embodiment of the present invention;

FIG. 7 is a view showing a display example of the TV receiver in the embodiment of the present invention;

FIG. 8 is a view showing a display example of the TV receiver in the embodiment of the present invention;

FIG. 9 is a flowchart showing a procedure of processing an event occurred by operating a remote controller;

FIG. 10 is a flowchart showing a channel switching process in a program information display area;

FIG. 11 is a flowchart showing a procedure of displaying a program schedule;

FIG. 12 is a flowchart showing a procedure of displaying program related information;

FIG. 13 is a flowchart showing a procedure of switching over the program to be watched in a TV broadcast display area;

FIG. 14 is a flowchart showing a procedure of displaying a homepage;

FIG. 15 is a flowchart showing a procedure of receiving a reserved program in the embodiment of the present invention;

FIG. 16 is a flowchart showing a procedure of displaying attached information of the reserved program;

FIG. 17 is a flowchart showing a procedure of displaying the attached information of the reserved program; and

FIG. 18 is a diagram showing a data structure of virtual channel information.

### DETAILED DESCRIPTION OF THE PREFERRED EMBODIMENT

The best mode for carrying out the present invention will be described by way of an embodiment.

Embodiment

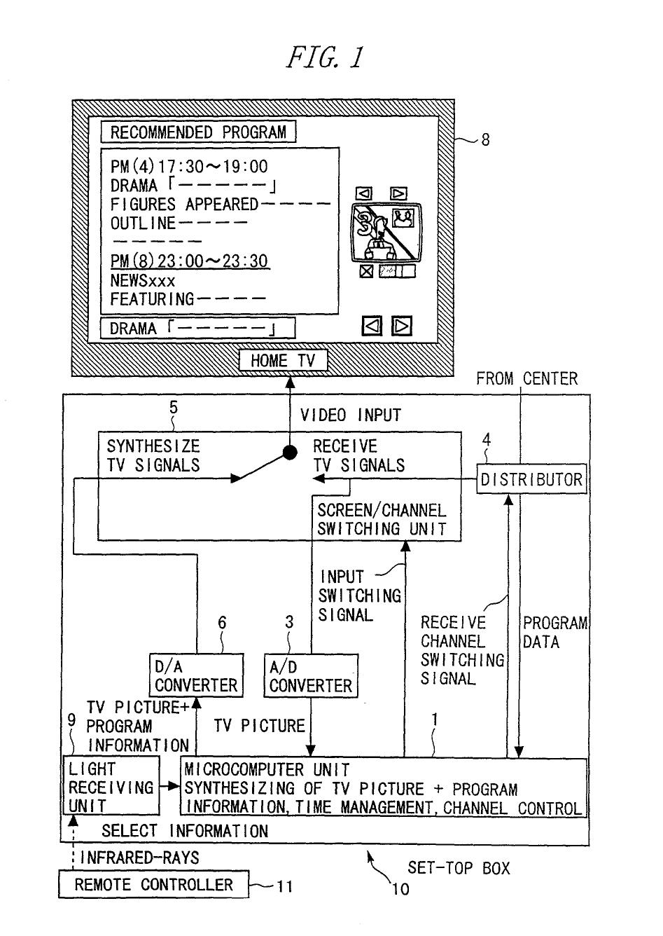

A television receiver in the embodiment of the present invention will be explained with reference to the drawings in FIGS. 1 through 18.

<Architecture>

FIG. 1 shows an architecture of the TV receiver in this embodiment. This TV receiver is used for receiving a broadcast of CATV etc. A program of the TV broadcast is distributed together with program data such as a broadcast schedule table and others from a CATV company (that will hereinafter be called a center).

As shown in FIG. 1, this TV receiver includes an STB 10 (set-top box) for receiving the TV broadcast, a TV monitor 8 for outputting a picture and sounds of the TV broadcast received, and a remote controller 11 (which will hereinafter be abbreviated to RC) utilizing infrared-rays, which is used for the user to operate the STB 10.

The STB 10 includes a distributor 4 for demultiplexing received signals into TV signals (that are called received TV signals. A content of the broadcast transmitted on these TV signals is called a main story) and into program data such as a program schedule etc, and for demodulating them, microcomputer unit 1 for controlling the whole STB 10, and A/D converter 3 for digitizing a television picture (TV picture) and inputting the TV picture to the microcomputer unit 1, a light receiving unit 9 for transferring operation signals from the RC 11 to the microcomputer unit 1, a D/A converter 6 for converting into TV signals a synthesized picture of the program information and the TV picture generated by the microcomputer unit 1, and a screen/channel switching unit 5 for switching over the TV signals (synthesized TV signals) containing the synthesized picture and as-received TV signals (received TV signals).

The distributor 4 demultiplexes the signals distributed from the center into the TV signals (TV picture and sounds) and the program data (digital data of the program schedule etc), and demodulates them. The TV signals are transferred to the screen/channel switching unit 5, while the program data are inputted to the microcomputer unit 1.

The A/D converter 3 converts the TV picture in the TV signals into digital data and inputs the digital data to the microcomputer unit 1.

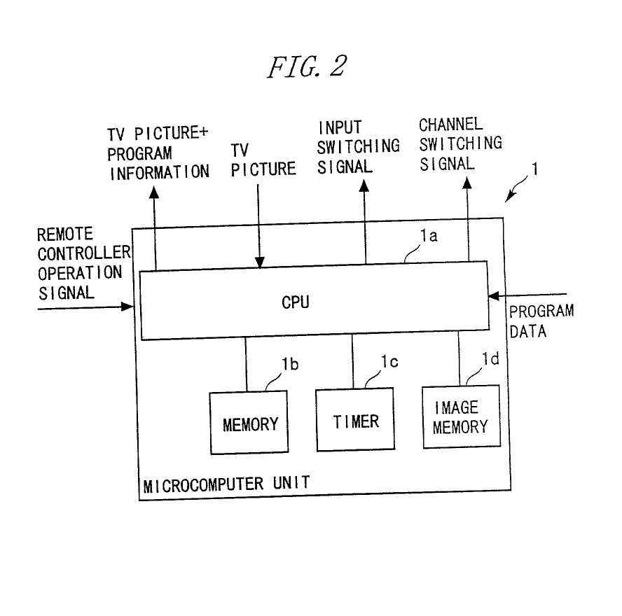

The microcomputer unit 1 includes, as shown in FIG. 2, a CPU 1a for executing a control program, a memory 1b for storing the control program and information on the programs, a timer 1c for notifying the CPU 1a of an elapse of a predetermined time, and an image memory id for retaining image data displayed on the screen of the TV monitor 8.

As shown in FIG. 2, the CPU 1a takes in the program data and the television picture (TV picture) from an I/O port thereof. The CPU 1a generates, from the program data, pieces of program information of the program schedule etc displayed on the TV monitor 8, then synthesizes the program information with the TV picture and outputs the TV picture synthesized with the program information. Further, the CPU 1a detects infrared-ray signals from the RC 11 via the light receiving unit 9. Moreover, the CPU 1a generates switching signals in accordance with an indication given from this RC 11, thereby switching over the screen displayed on the TV monitor 8.

The D/A converter 6 converts the synthesized signals of the program information and the TV picture generated by the microcomputer unit 1 into synthesized television signals.

<Layout on Display Screen>

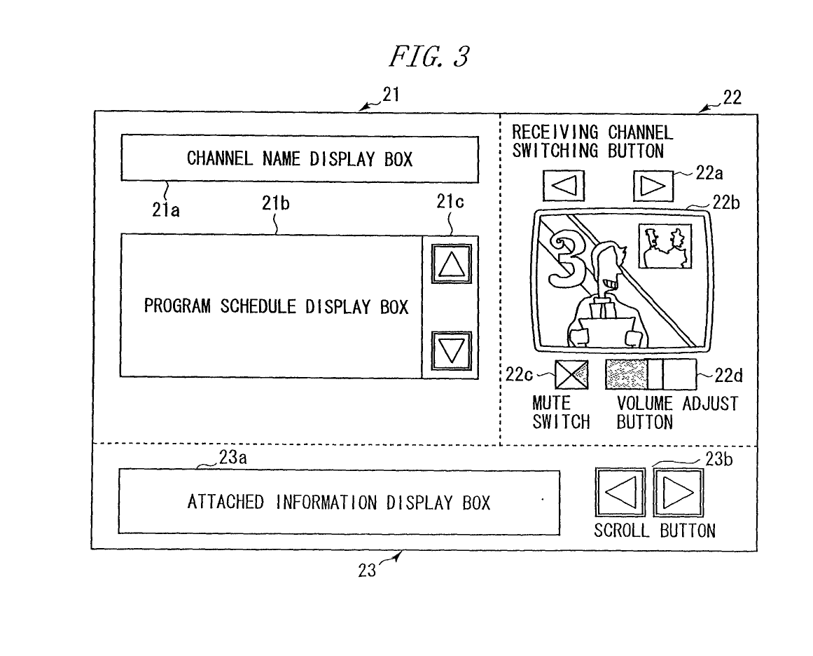

FIG. 3 shows a display screen of the TV receiver in this embodiment. As illustrated in FIG. 3, this display screen includes a program information display area 21, a main story display area 22 and an attached information display area 23. The main story herein is the program itself such as a drama, news etc broadcast at each channel.

The program information display area 21 contains a channel name display box 21a for displaying a name of the channel displayed, a program schedule display box 21b and scroll buttons 21c.

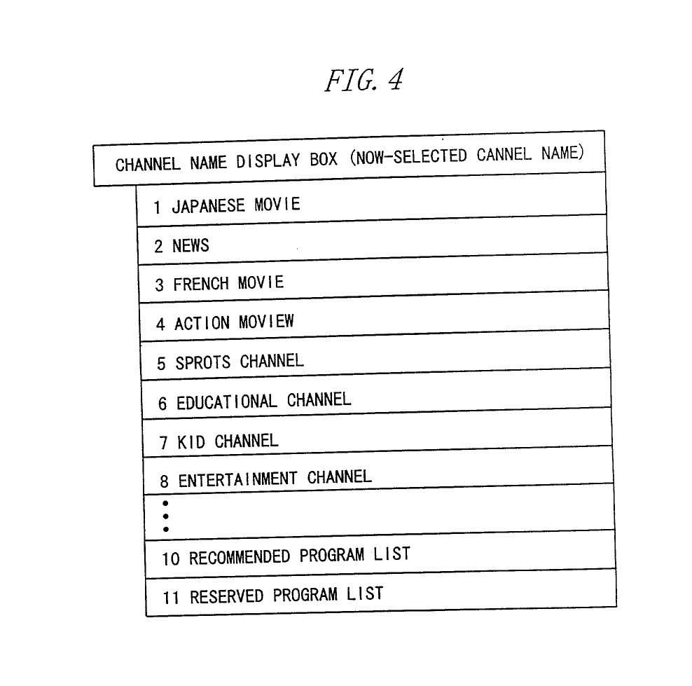

The name of the channel selected by the user is displayed in the channel name display box 21a. Further, the channel name display box 21a forms a pull-down menu (corresponding to a display channel selection module), wherein when the user indicates a position of the channel name display box 21a by the RC 11, a channel list as shown in FIG. 4 is displayed. The user selects a desired channel from the channel list, whereby the information containing program schedules of the respective channels can be displayed in the program schedule display box 21b.

This list of channel names contains, in addition to the channels (broadcast channels) that are actually broadcast as a Japanese movie of the channel 1 and News of the channel 2 shown in FIG. 4, virtual channels consisting of a plurality of broadcast channels combined on a time-division basis such as a recommended program list shown as a channel 10 and a reserved program list shown as a channel 11.

The program schedule of the channel selected as described above is displayed in a time-series order in the program schedule display box 21b, wherein the name of the program being now broadcast at this channel is headed. Further, pieces of information as detailed information on the respective programs such as an epitome of the drama as a program, figures appeared therein, a caption of the program etc are displayed in the program schedule display box 21b.

The main story display area 22 contains receiving channel switching buttons 22a, a TV broadcast display box 22b, a mute (silence) switch 22c (corresponding to a mute switching module), and a volume adjust button 22d. A picture of the TV signals, which is watched by the user, is displayed in the TV broadcast display box 22b. A content displayed in this TV broadcast display box 22b can be switched over by the receiving channel switching buttons 22a. Further, the sound can be adjusted by use of the mute (silence) switch 22c and the volume adjust button 22d.

The mute switch 22c can be set ON or OFF by operating the RC 11 on the screen of the TV monitor 8. When the mute switch 22c on this screen is set ON, the CPU 1a controls the distributor 4 to remove the sounds from the demodulated signals and thus output the signals.

The volume adjust button 22d is likewise operable by the RC 11 on the screen of the TV monitor 8. The CPU 1a calculates a ratio with respect to a full scale from a volume position on this screen. The calculated ratio is transferred to the TV monitor 8 and set in an unillustrated sound volume register built in the TV monitor 8, thereby specifying an output of an amplifier of the TV monitor 8.

Further, when selecting a position of the TV broadcast display box 22b by use of the RC 11, the TV broadcast display box 22b is enlarged over the entire screen, wherein the display screen of the TV monitor 8 thus becomes a normal TV broadcast receiving screen (the RC11 corresponds to an enlargement indicating unit).

The attached information display area 23 contains an attached information display box 23a (corresponding to an information display module) and scroll buttons 22b. A headline of the information attached to the program , which is broadcast at the present at each channel, is displayed in this attached information display box 23a. Moreover, when this headline is selected by use of an operation button of the RC 11, detailed information thereof such as a program caption, a program homepage etc is displayed in the program schedule display box 21b.

Further, in the attached information display box 23a, a piece of information notifying that the program starts being broadcast immediately before the start of broadcasting the program reserved by the user, and, when reaching the broadcast start time, the information that this program will be broadcast soon is displayed.

Moreover, the attached information display box 23a contains a hyperlink module hyperlinked to a program homepage, a homepage of a program supplier, a homepage of a sponsor and so on, wherein the related information is displayed by selecting them.

<Operation>

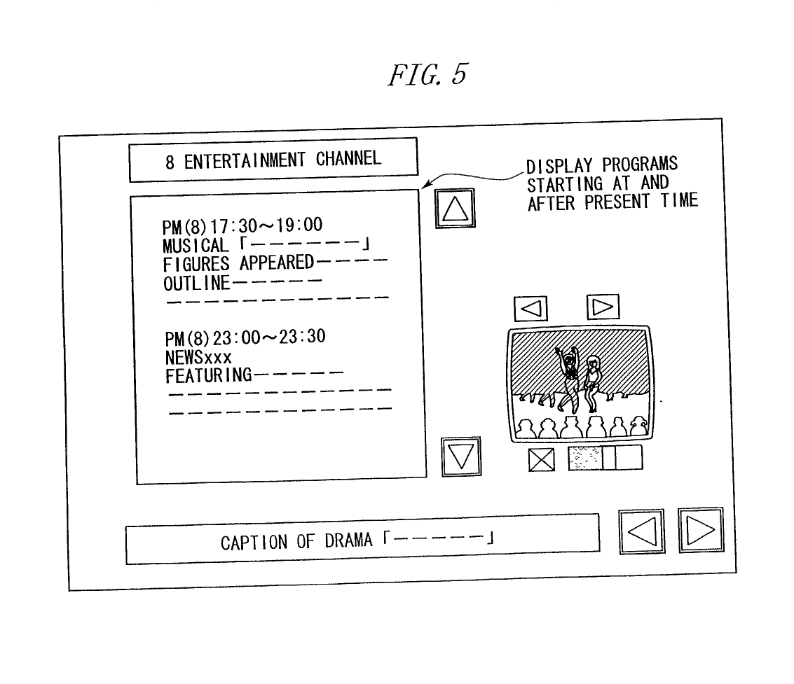

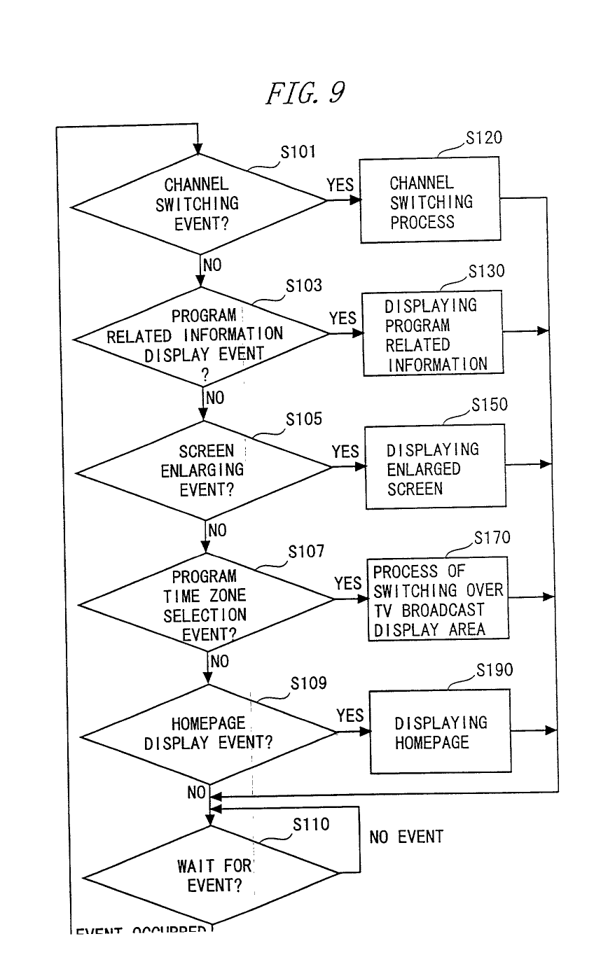

FIGS. 5 through 8 show examples of the display screen on the TV receiver in this embodiment. Processing procedures for displaying these screens will hereinafter be explained referring to FIGS. 9 through 15.

The CPU 1a of the microcomputer unit 1 shown in FIG. 1 executes the control program stored in the memory 1b, thereby executing the processes shown in FIGS. 9 through 14. As shown in FIG. 9, the CPU 1a is normally in a wait-for-event status (step 110 that will hereinafter be abbreviated to S110), and executes each process corresponding to an event that the user operates the RC 11.

The “event” herein implies an occurrence of information that changes a control status of the CPU 1a, and in this embodiment corresponds to a generation of the operation signal of the RC 11. The CPU 1a executes, corresponding to a category of this event, as shown in FIG. 9, a channel switching process (S120) displaying program-related information (S130), displaying an enlarged screen (S150), a process of switching over the TV broadcast display area (S170) and displaying the homepage (Sl90)

<Channel Switching Process>

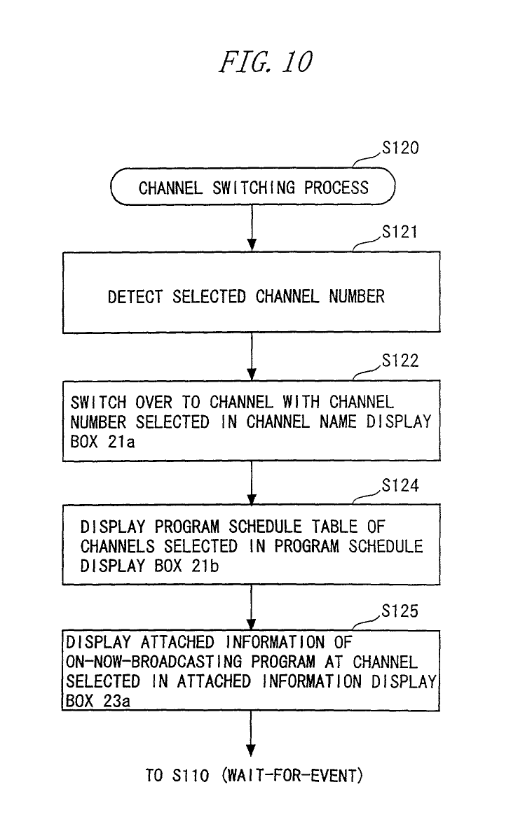

FIG. 10 shows a procedure of the channel switching process. Herein, the channel switching process is a process of switching over the channel of which the information is displayed in the program information display area 21. Accordingly, this process does not imply that the picture in the TV broadcast display box 22b is not immediately switched off.

To start with, the CPU 1a detects a channel number selected from the channel list (pull-down menu) shown in FIG. 4 (S121). Next, the CPU 1a switches over the channel name display box 21a to a channel of the channel number selected (S122). Subsequently, the CPU 1a displays a program schedule of the selected channel in the program schedule display box 21b (S124). Next, the CPU la displays attached information of the program being now broadcast at the selected channel in the attached information display box 23a (S125), and reverts again to the wait-for-event status (S110).

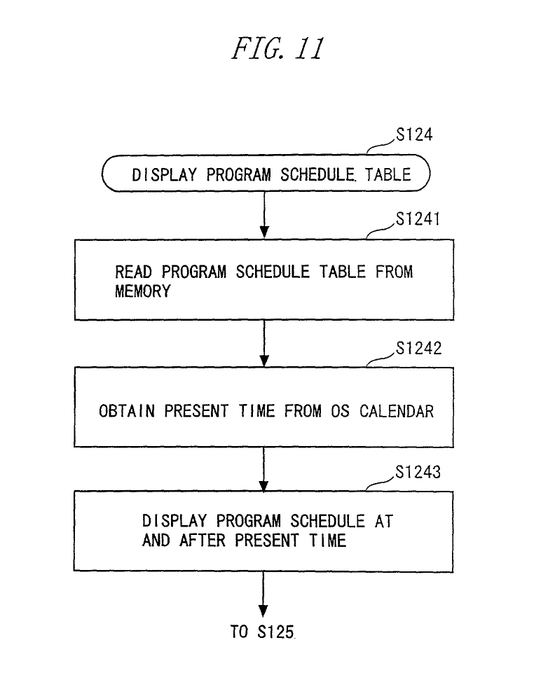

In the process in S124 described above, the programs subsequent to the now-broadcasting program inclusive are displayed in the program schedule display box 21b. The details thereof are shown in a flowchart in FIG. 11. To begin with, the CPU 1a receives from the center and reads the program schedule table stored in the memory 1b (S1241). Next, the CPU 1a obtains the present time from a calendar of an OS (S1242). Subsequently, the CPU 1a obtains the programs from the present time onward out of the program schedule and displays these programs in the program schedule display box 21b (S1243) FIG. 5 illustrates an example of the screen on the TV monitor 8 that is displayed as described above.

<Display of Program Related Information>

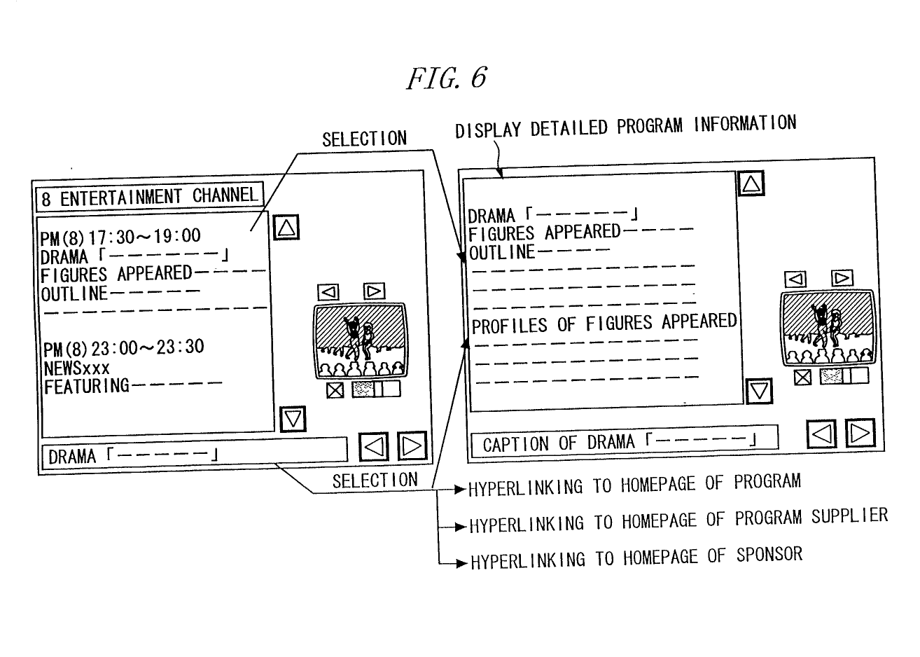

Given next is an explanation of a process if the event is to display the program related information. Herein, the display of the program related information is a process of displaying, when the user specifies a program name (a drama as an entertainment program at the channel 8 in FIG. 6) by operating the RC 11 as shown in FIG. 6, the information related to this program. This kind of program related information may be a outline of the program, profiles of the figures appeared, a program caption and others. The program related information described above is periodically distributed together with the program schedule table from the center.

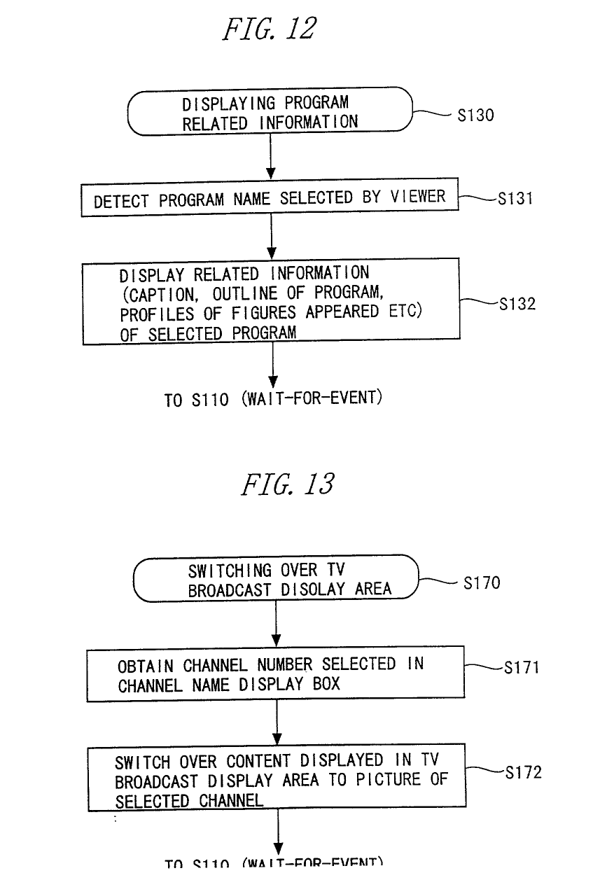

FIG. 12 shows a flowchart of the program related information display process. At first, the CPU 1a detects the program name specified by the user by use of the RC 11 from the program schedule displayed on the screen (the program schedule display box 21b) of the TV monitor 8 (S131). Next, the CPU la reads the related information related to this program from the memory 1b in accordance with the program table distributed from the center, and displays the related information in the program schedule display box 21b. FIG. 6 shows a screen transition when the program related information is displayed by the operation described above.

The user is thus able to check what programs are broadcast at other channels by displaying the information on the programs of other channels in the program schedule display box 21b in a way that continues the display of the picture at the specified channel in the TV broadcast display box 22b.

<Display of Homepage>

Given next is a description of a process if the event is to display the homepage. The homepage is displayed when the user selects a specified keyword (hyperlinked to the homepage) by operating the RC11.

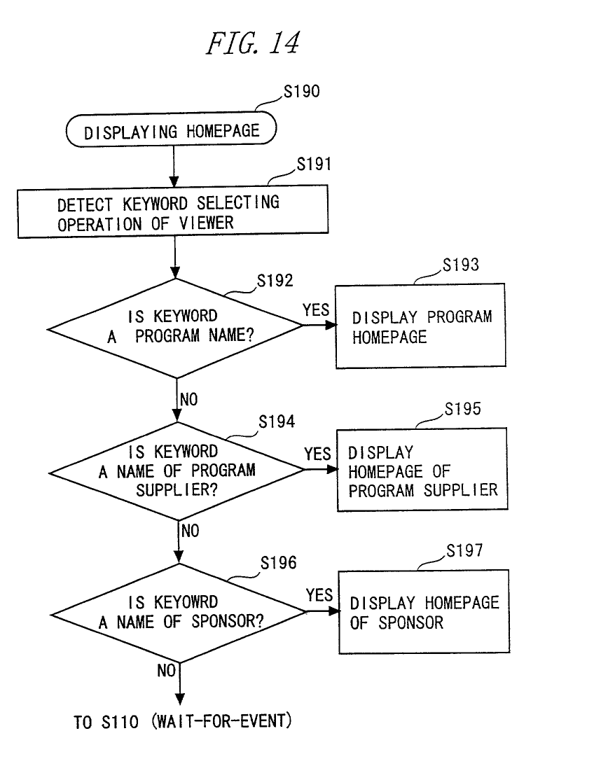

In this embodiment, a name of a specified program, a name of a program supplier and a name of a sponsor may be defined as keywords hyperlinked to the homepages. When the user selects a position of such a keyword by the RC 11, the homepage of the program (S193), the homepage of the program supplier (S195) and the homepage of the sponsor (S197) are displayed based on a flowchart in FIG. 14. FIG. 6 shows the transition of the screen operated as described above.

<Process of Switching over TV Broadcast Display Area>

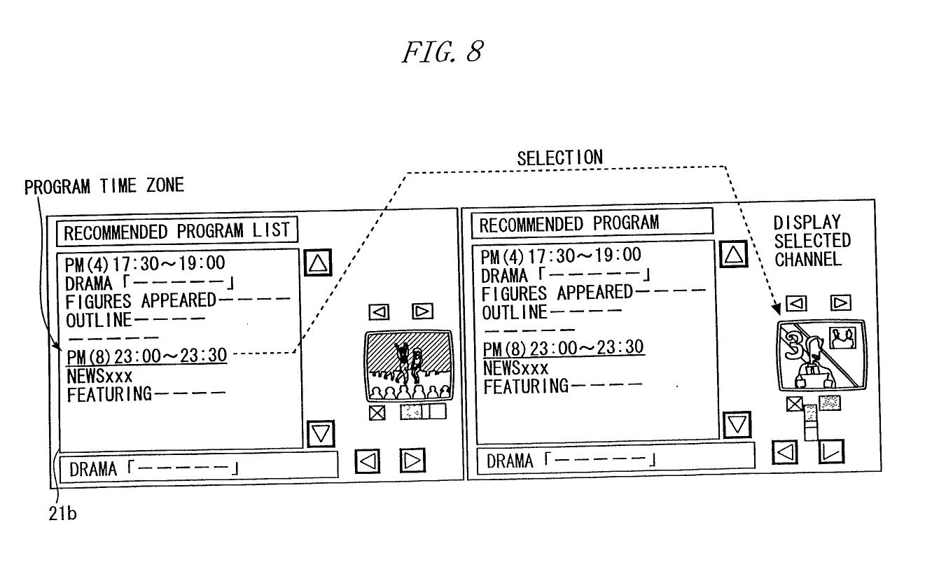

Next, a process when the event is to select a program time zone, will be explained. The selection of the program time zone is implies that a program time zone displayed in the program schedule display box 21b is, as illustrated in FIG. 8, selected by the users operating the RC11. In this embodiment, with the program time zone selection event, the picture in the TV broadcast display box 22b is switched over to a channel (the channel displayed in the channel name display box 21a when this program time zone selection event occurs) of the program with the selected time zone indicated.

This switching process with respect to the TV broadcast display box 22b will be explained in accordance with a flowchart in FIG. 13. At first, the CPU 1a obtains the channel numbers displayed in the channel name display box 21a (S171). Next, the CPU 1a generates a channel switching signal, thereby switching over the channel that should be selected by the distributor 4. As a result, the display in the TV broadcast display box 22b is switched to the selected channel program. FIG. 8 shows a screen transition described above.

The user is thereby able to check the contents of the broadcasts of other channels in a state of displaying the now-watching program and to switch over the picture in the TV broadcast display box 22b to that channel if the content of the broadcast conforms with a desire for watching.

Next, a process if the event is a selection of the TV broadcast display box 22b (which corresponds to an indication of enlarging the screen) (this even may be called an enlarged screen display event), will be described. In the TV receiver in this embodiment, when the user selects the TV broadcast display box 22b, the TV broadcast display box 22b is enlarged over the entire screen of the TV monitor 8, wherein the TV monitor 8 is operated as a normal TV screen.

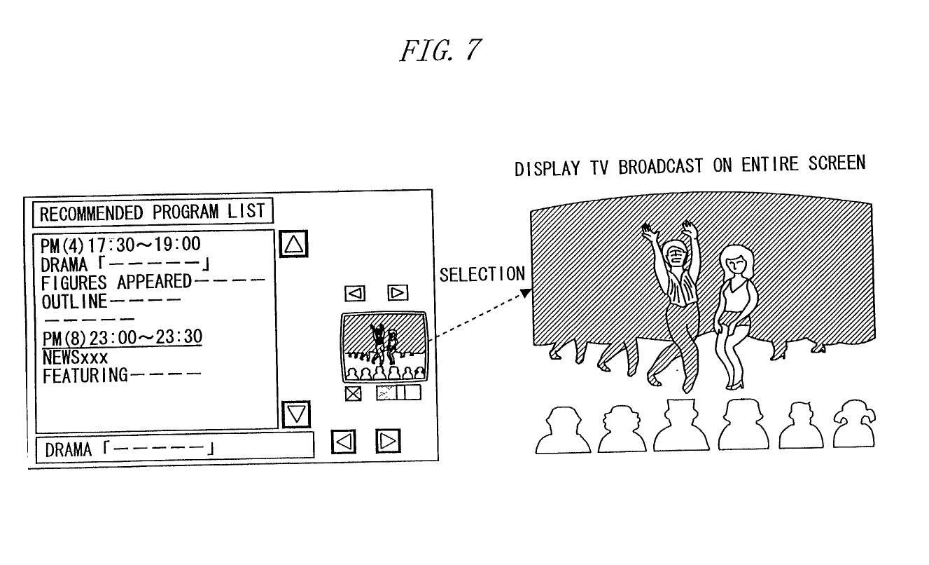

Namely, the CPU la, when detecting the enlarged screen display event, generates the channel switching signal and, in the screen/channel switching unit 5, outputs the receiving TV signal directly to the TV monitor 8. FIG. 7 shows a screen transition based on the operation described above. The user is thereby able to enjoy the program by use of the entire screen of the TV monitor 8.

<Receipt Assisted by Recommended-Program List>

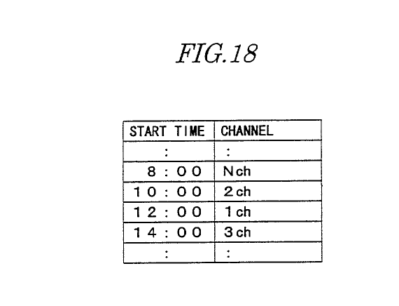

In the TV receiver in this embodiment, it is possible to select the recommended-program list by the channel selection from the channel list (pull-down menu) shown in FIG. 4. The recommended-program list corresponds to the virtual channels consisting of the plurality of channel programs combined on the time-division basis. The recommended-program list is distributed normally via a CATV network from the center and stored in the memory lb. FIG. 18 illustrates a data structure (that will herein after be called virtual channel information) thereof.

Referring to FIG. 4,a channel number 10 is allocated as the recommended-program list, thus configuring a virtual channel 10. Accordingly, the user selects the recommended-program list in the channel name display box 21a, whereby the information on the programs recommended by the center can be displayed in the program schedule display box 21b.

FIGS. 7 and 8 show a display example of the program schedule display box 21b in this case. As illustrated in FIGS. 7 and 8, when the virtual channel information such as the recommended-program list is displayed in the program schedule display box 21b, physical channels contained in this item of virtual channel information are displayed as PM(4) and PM(8) (indicating the channel 4 and the channel 8 in FIG. 7).

Further, one of the programs thereof maybe selected (based on the selection of the program time zone described above), and the picture thereof can be displayed in the TV broadcast display box 22b.

<Receipt of Reserved Program>

In the TV receiver in this embodiment, the program received by utilizing the virtual channel information explained above can be reserved. To be specific, based on the data structure shown in FIG. 18, a time zone and a channel number that should be received in this time zone are stored in the memory 1b, and the CPU 1a switches over the receiving channel in every time zone.

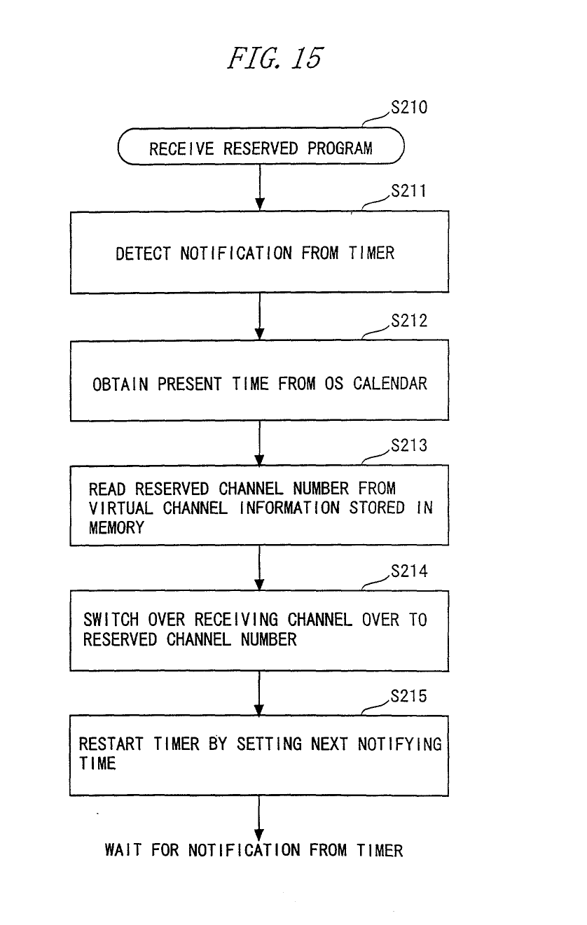

FIG. 15 shows a process executed by the CPU 1a in this case. At first, the timer 1c in which the time is specified beforehand notifies the CPU 1a that a predetermined time has elapsed (S211). After detecting this notification from the timer 1c, the CPU 1a obtains the present time from the OS calendar (S212). Next, the CPU 1a reads a reserved channel in the time zone containing the obtained present time from the virtual channel information (FIG. 18) in the memory 1b (S213). Subsequently, the CPU 1a switches over the receiving channel to be demodulated by the distributor 4 to the reserved channel number (S214). The picture to be displayed on the TV monitor 8 is there by changed into a picture of the reserved channel number. Further, the CPU 1a sets the timer 1c to notify of the time at which the channel should be changed next (S215), and waits for a notification from the timer 1c.

Thus, the channel that should be received can be automatically switched over in accordance with the virtual channel information in FIG. 18.

The virtual channel information (corresponding to program reservation information) as the reserved program list may be allocated to the specified channel number (the channel number is “11” in FIG. 4), whereby the reserved program list can be displayed for confirmation in the program schedule display box 21b in the same procedure as the recommended-program list described above.

<Display of Attached Information of Reserved Program>

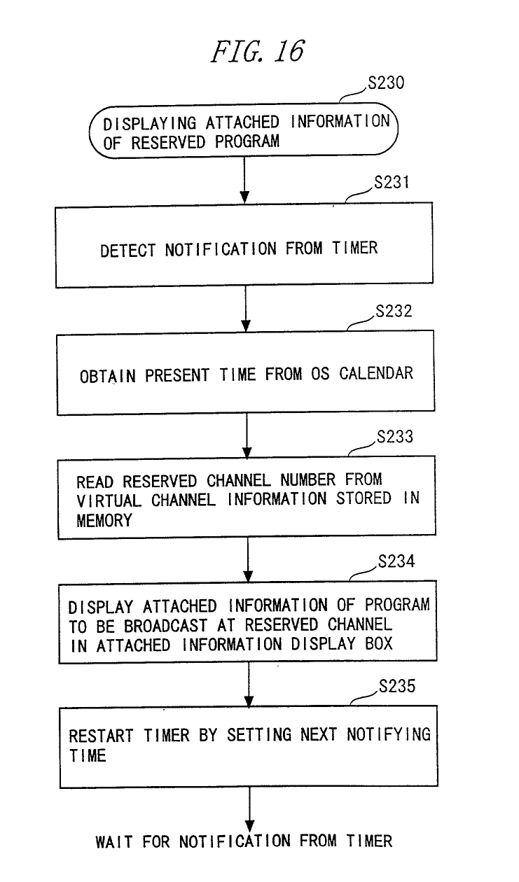

In the TV receiver in this embodiment, a message saying that the reserved program will be broadcast and information on the reserved program can be further displayed in the attached information display box 23a. To be specific, the CPU 1a searches for the channel number reserved in each time zone in accordance with the virtual channel information in FIG. 18 that is stored in the memory 1b, and, when it is the broadcast start time, notifies the user that this broadcast is to broadcast. Further, the CPU 1a displays the attached information related to this program. This process will be explained referring to a flowchart in FIG. 16.

At first, the timer 1c in which the time is specified beforehand notifies the CPU 1a that a predetermined time has elapsed (S231). After detecting this notification from the timer 1c, the CPU 1a obtains the present time from the OS calendar (S232). Next, the CPU 1a reads a reserved channel in the time zone containing the obtained present time from the virtual channel information (FIG. 18) in the memory 1b. Moreover, the CPU 1a reads the attached information by referring to the program schedule table distributed from the center on the basis of the reserved channel number and the reserved time (S233). Next, the CPU 1a displays the message saying that the broadcast of this program is started, and the readout attached information in the attached information display box 23a (S234). Further, the CPU 1a sets the timer 1c to notify of the time at which the receipt is reserved next (S235), and waits for a notification from the timer 1c.

<Modified Example>

In the embodiment discussed above, the TV picture is inputted to the CPU 1a via the D/A converter 3. The embodiment of the present invention is not, however, limited to this. For example, in the case of receiving the digital broadcast, the picture received may be inputted directly to the CPU la. In this case, the D/A converter 3 is not required.

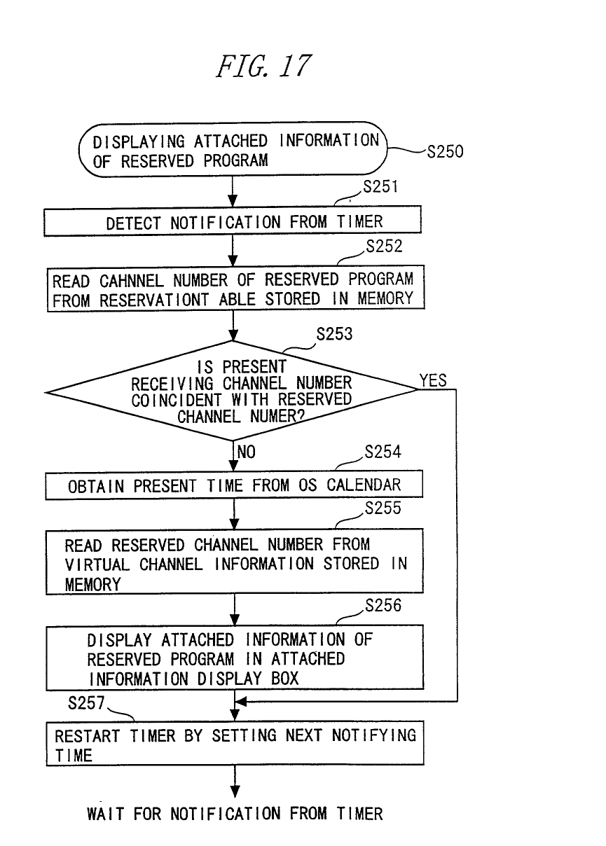

The embodiment of the present invention discussed above has exemplified the process of displaying, when it is a time for broadcasting the reserved program, the message saying that the broadcast of the reserved program will be started and the attached information of this program. If the reserved program is displayed on the TV monitor 8, however, it can be considered that there is no necessity of displaying the message saying that the broadcast of the reserved program will be started and the attached information thereof. Then, FIG. 17 shows an example of the process of displaying the broadcast start message the reserved program and the attached information as far as a case of not receiving the reserved program is concerned.

The processes in FIG. 17 are substantially the same as the processes in FIG. 16, however, a judgement as to whether the present receiving channel is coincident with the reserved channel, is added to the process in S253. As a result, if the receiving channel is not coincident with the reserved channel, i.e., as far as the case of not receiving the program of the reserved channel is concerned, there are displayed the message saying that the broadcast of the reserved program will be started and the attached information.

This message and the attached information may be displayed, as shown in FIG. 16 or 17, just when the reserved program is started or before a predetermined time since the program was started.

In the embodiment discussed above, after changing the channel in the channel name display box 21a or at the time when the reserved program is broadcast, the information related to this channel and the program is displayed in the attached information display box 23a. In addition to those described above, for instance, an outline etc of the program being now broadcast at each channel may be broadcast in circulation as the attached information. For attaining this, the CPU 1a, when receiving the periodic notification from the timer 1c, may sequentially search for the program schedule distributed from the center and may display it in the attached information display box 23a.

In the embodiment discussed above, the program schedule and the program-related information (the outline of the program, the figures appeared, the caption and others) are distributed as the program data from the center but may be taken in via the Internet. Further, a magazine article etc carrying the program information may be key-inputted by operating a switch of the RC 11.

In the embodiment discussed above, the time zone displayed in the program schedule display box 21b is selected in order that the program (main story) displayed in the TV broadcast display box 22b is switched over. As a substitute for this, however, the program displayed in the TV broadcast display box 22b may be switched over by selecting the program name.

The pull-down menu displayed on the screen of the TV monitor 8 has been explained as the display channel selection module in the embodiment described above. The display channel may be, however, switched over only by manipulating the button on the RC 11 without using the pull-down menu. For example, the light receiving unit 9 may detect the infrared-ray signal generated by pressing the volume button of the RC 11, and the display channel number may be ascended or descended corresponding to a press count thereof.

The TV receiver in this embodiment is also actualized in such a way that a computer executes a program which runs to display the screen containing the channel name display box, the program schedule display box for displaying the information containing the program schedule of the programs broadcast at the channel displayed in the channel name display box, and the TV broadcast display box for displaying the TV broadcast received, and enables the confirmation of the program schedule and the watching of the TV broadcast on the same screen.

This program can be recorded on a readable-by-computer recording medium such as a floppy disk, a magneto-optic disk, a CD-ROM, a CD-R/W, an MO, a DVD, a DAT, an 8 mm tape, a memory card etc. Further, this program can be stored in a hard disk and a memory of the computer, and can be distributed to other computers via a communication line. As a result, the computer receiving the distribution of this program can be made to function as the TV receiver in this embodiment.

Industrial Applicability

The present invention is, in the TV broadcast consisting of the multiplicity of channels, useful for manufacturing the TV receiver including the display screen capable of displaying the information on the programs that are being broadcast at other channels simultaneously with displaying the on-watching program, the information containing the program schedules of the respective broadcast channels, or the program reservation information extending to one or more broadcast channels.

What is claimed is:

1. A television receiver comprising:
a screen including a channel name display area, a program schedule display area for displaying information containing a schedule of programs broadcast at channels displayed in said channel name display area, and a television broadcast display area for displaying the television broadcast received; and
a display channel selection module selecting the channel displayed in said channel name display area,
wherein the program schedule can be confirmed and the television broadcast can be watched on said same screen.

2. A television receiver according to claim 1, wherein said screen further includes an information display area for displaying information about an on-broadcast program or
information on the program scheduled to be broadcast, and information on programs to be broadcast at the channels of the television broadcasts received or programs to be broadcast at other channels, is displayed in said information display area.

3. A television receiver according to claim 1, further comprising enlargement indicating unit indicating an enlargement of said television broadcast display area,
wherein said television broadcast display area is, upon the indication by said enlargement indicating unit, enlarged and displayed over said entire screen.

4. A television receiver according to claim 1, further comprising indicating unit for indicating said program schedule display area,
wherein the channel of the television broadcast received is switched over by indicating a position related to said program schedule display area.

5. A television receiver according to claim 1, further comprising indicating unit for indicating said program schedule display area,
wherein the information related to the program shown in the program schedule is displayed by indicating a position related to said program schedule display area.

6. A television receiver according to claim 1, wherein said program schedule display area displays the program schedule, starting from a program that is now being broadcast or a program of which the broadcast starts earliest at and after the present time.

7. A television receiver according to claim 1, further comprising a scroll area for scrolling the program schedule.

8. A television receiver comprising:
a screen including a program reservation information display area for displaying program reservation information extending to one or more broadcast channels and including combinations of information of one or more reserved programs to be watched and information containing a broadcast time and a broadcast channel of each of the reserved programs, and a television broadcast display area ford is playing a non-receiving television broadcast,
wherein the program reservation information can be confirmed and the television broadcast can be watched on said same screen.

9. A television receiver according to claim 8, wherein said program reservation information display area displays the program reservation information, starting from a program that is now being broadcast or a program of which the broadcast starts earliest at and after the present time.

10. A television receiver according to claim 8, wherein the broadcast channel received when it is a broadcasting time of the program reserved by the program reservation information, is switched over to a broadcast channel of the reserved program.

11. A television receiver according to claim 8, wherein information on the reserved program is displayed at the broadcasting time of the program reserved by the program reservation information or before a predetermined time since this broadcasting time.

12. A television receiver according to claim 11, wherein the information on the reserved program is displayed if the broadcast channel at which the reserved program is broadcast, is not watched.

13. A television receiver according to claim 8, further comprising a scroll area for scrolling the program reservation information.

14. A television receiver according to claim 1 or 8, further comprising a volume adjusting module adjusting a volume of the television broadcast received, a mute switching module, or a receiving channel switching module switching over the broadcast channel received.

15. A readable-by-computer recording medium recorded with a program, to make a computer control a television receiver, comprising:
displaying a screen including a channel name display area, a program schedule display area for displaying information containing a schedule of programs broadcast at channels displayed in said channel name display area, and a television broadcast display area for displaying the television broadcast received,
wherein confirming the program schedule and watching the television broadcast on said same screen are enabled.
